(19) United States
(12) Patent Application Publication
(10) Pub. No.: US 2012/0182905 A1
(43) Pub. Date: Jul. 19, 2012

(54) COMMUNICATION SYSTEM AND COMMUNICATION DEVICE

(75) Inventor: Takashi Tsurumoto, Saitama (JP)

(73) Assignee: SONY CORPORATION, Tokyo (JP)

(21) Appl. No.: 13/343,947

(22) Filed: Jan. 5, 2012

(30) Foreign Application Priority Data
Jan. 13, 2011 (JP) P2011-004613

(51) Int. Cl. H04B 7/00; H04W 72/04

(52) U.S. Cl. 370/277

(57) ABSTRACT

A communication system is provided, including a remote control for transmitting a remote control code corresponding to a user operation and a host apparatus for performing processing according to the remote control code, in which the host apparatus is configured to determine a frequency channel for a communication section included therein to be on receiving standby, the remote control is configured to transmit a channel shift request to the host apparatus when a signal is not transmitted on the frequency channel which the host apparatus is on receiving standby, and the host apparatus is also configured to change the frequency channel on which the communication section is on receiving standby after receiving the channel shift request.

### CROSS-REFERENCE TO RELATED APPLICATION

The present application claims priority from Japanese Patent Application No. JP 2011-004613 filed in the Japanese Patent Office on Jan. 13, 2011, the entire content of which is incorporated herein by reference.

### BACKGROUND

The present disclosure relates generally to communication systems and communication devices, including remote controls and host apparatuses. More particularly, the disclosure relates to a communication system and device, including a remote control to remotely operate by transmitting remote control codes and a host apparatus as subject of operation by the remote control codes, while performing bidirectional communication using a wireless network.

At present, in television sets, AV appliances, and many other information apparatuses, the remote-control operation with remote controls is widely adopted. In the present disclosure, the apparatus body to be subjected to the remote-control operation will be collectively called as “host apparatus”.

As a means of communication with remote controls, infrared communication has been utilized. Although infrared transmission has advantages of relatively inexpensive and of less power consumption, it has shortcomings such as being limited to one-way communication and having sharp directivity. By contrast, with remote controls of RF type using a wireless network as the means of communication, the bidirectional communication becomes possible between host devices and also the range of communication is expanded.

For example, Zigbee RF4CE (hereafter, referred to as “RF4CE”) is the standard of remote control functions developed primarily for consumer electronics products. Three frequency channels are provided in RF4CE. Immediately after installing a host device, the implementation scheme of setup is specified, as the default, to use the channel least interfering with the host device among the three frequency channels. On the side of the remote control, it is set to follow the frequency channel determined by the host apparatus. In addition, the remote control is configured to perform interference avoidance according to the rules of CSMA (Carrier Sense Multiple Access) which is also adopted by MAC layer of IEEE 802.15.4.

Since the PHY/MAC layer of IEEE 802.15.4 is herein adapted with RF4CE using the 2.4 GHz frequency band which is available without license requirement, a number of sources of disturbance exist such as a microwave oven, wireless LAN (local area network) and so forth, giving rise to a problem such as for RF remote control to be suffered from interference or to cause interference with neighboring systems.

For example, a remote control system has been proposed which enables remote control operations while avoiding interference by seeking a channel available, selecting the channel as a communication channel, and subsequently making change (for example, Japanese Unexamined Patent Application Publication No. 2009-267560). In this system, when the electric field intensity of received signal exceeds a threshold value continuously a predetermined number of times, a host apparatus such as television changes its transceiver channel by switching, in predetermined order, the channels which are specified beforehand as suffering little interference. The remote control on the other side also switches the channels like host apparatus, when a response signal ACK is not received within a definite period of time.

In the RF4CE, the remote control side is not authorized to make a change of frequency channel, but follows the frequency channel which the host apparatus determined. Since the remote control and the host apparatus are operated in the same room, it is typically assumed that the remote control and the host apparatus are located relatively close to each other, and that the energy level of the disturbance waves, which is received respectively by the remote control and host apparatus, is in the same order of magnitude even in the presence of disturbance sources around. Therefore, since the frequency channel, on which the remote control does not transmit at all according to CSMA, is similarly affected by the interference on the side of the host apparatus, to thereby make changes automatically to other frequency channels, and it is possible to carry out the communication constantly while avoiding the interference with each other.

However, for some reason, if a difference arises between the remote control and the host apparatus in the influence from the same source of disturbance, particularly, as in the case where the remote control suffers from the interference at a strong level while the level of the interference suffered by the host apparatus is weaker, there is a possibility of getting into a situation where the communication is not carried out properly. This is caused by the fact that the side of host apparatus does neither detect disturbance waves, nor make a change of frequency channel, while the side of the remote control detects disturbance waves on the same frequency channel and does not access according to the interference avoidance (CSMA).

### SUMMARY

The present disclosure addresses the foregoing and other problems associated with previous communication systems. It would be desirable, therefore, to provide outstanding communication systems and apparatuses capable of suitably performing the bidirectional communication between a remote control and host apparatuses using a wireless network.

It is further desirable for the disclosure that the communication systems and apparatuses can communicate suitably even in the case when a difference arises between the remote control and the host apparatus in the effect suffered from the same source of disturbance, while avoiding the interference from sources of disturbance.

In order to overcome the difficulties mentioned earlier, and to achieve the desirable capabilities for the communication systems and apparatuses in the present disclosure, a communication system is provided according to an embodiment, including a remote control including an input section for inputting a user operation and a first communication section for performing a bidirectional communication on any one of at least two frequency channels, so as to transmit a remote control code corresponding to a user operation of the input section; and a host apparatus including a second communication section for performing a bidirectional communication on any one of the at least two frequency channels and a host function section for performing a processing according to the remote control code received by the second communication section; in which the host apparatus is configured to determine a frequency channel for the second communication section to be on receiving standby, the remote control is configured to transmit a channel shift request to the host apparatus when a signal is not sent through on the frequency channel which the host apparatus is on receiving standby, and the host apparatus is also configured to change the frequency channel on which the second communication is on receiving standby after receiving the channel shift request.

It may be noted that the term “system” mentioned herein refers to things logically assembled of plural devices (or functional modules for realizing specific functions), and it is not particularly concerned whether or not each of the devices and functional modules are in a single enclosure.

In the abovementioned communication system, the remote control may direct the frequency channel to be changed through the channel shift request. In such a case, the host apparatus may change the frequency channel on which the host apparatus is on receiving standby to the frequency channel directed through the channel shift request received.

Also in the communication system, the host apparatus is configured to return a response signal when a signal is received from the remote control. On the other hand, the remote control does not carry out the transmission on the frequency channel according to CSMA, in which an energy level of disturbance waves exceeds a predetermined transmission shutoff level. In addition, if a response signal is not received, the remote control transmits another signal after changing the frequency channel, and further, when a response signal can be received from the host apparatus on the frequency channel onto which the another signal was transmitted, the remote control is configured to recognize that the host apparatus is on receiving standby on the frequency channel.

Furthermore, in the abovementioned communication system, when a frequency channel exists on which the transmission is not feasible, and a response signal is not received even after performing the transmission sequentially more than a predetermined times onto the frequency channels other than the abovementioned frequency channel, the remote control is configured to transmit a channel shift request to the host apparatus.

According to an alternate embodiment, a communication device functioning as a remote control is provided. The communication device includes an input section for inputting a user operation and a communication section for performing a bidirectional communication on any one of at least two frequency channels, in which the communication device is configured to transmit a remote control code corresponding to a user operation of the input section from the communication section to the host apparatus to be a subject of operation, and to transmit a channel shift request to the host apparatus when a signal is not sent through on the frequency channel which the host apparatus is on receiving standby.

In the abovementioned communication device, it may be configured to direct the frequency channel to be shifted through the channel shift request. In such a case, the host apparatus, which received the channel shift request, may shift the frequency channel on which the host apparatus is on receiving standby to the frequency channel directed through the channel shift request received.

Also in the communication device, the host apparatus is configured to return a response signal, when a signal is received from the remote control. In addition, the communication section included in the communication device does not carry out the transmission on the frequency channel according to CSMA, in which an energy level of disturbance waves exceeds a predetermined transmission shutoff level. When the communication section does not receive a response signal, the section transmits another signal after changing the frequency channel, and further, when a response signal can be received from the host apparatus on the frequency channel onto which the another signal was transmitted, the remote control is configured to recognize that the host apparatus is on receiving standby on the frequency channel.

Furthermore, in the communication section included in the communication device, when a frequency channel exists on which the transmission is not feasible, and a response signal is not received even after transmitting signals sequentially more than a predetermined times onto the other frequency channels, the section is configured to transmit a channel shift request to the host apparatus.

In another embodiment, a communication device as a subject of operation by a remote control is provided. The communication device include a communication section for performing a bidirectional communication with a remote control on any one of at least two frequency channels and a host function section for performing a processing according to the remote control code received by the communication section, in which the communication section determines a frequency channel to be on receiving standby, and changes the frequency channel on receiving standby in response to a reception of a channel shift request from the remote control.

In the abovementioned communication device, the frequency channel to be changed is directed by the channel shift request received. In addition, the communication section included in the communication device may shift the frequency channel to be on receiving standby to the frequency channel directed through the channel shift request received.

With the communication system and communication device in the present disclosure described hereinabove, outstanding communication systems and apparatuses can be provided, being capable of suitably performing the bidirectional communication between a remote control and host apparatuses using a wireless network.

In addition, according to the embodiments, excellent communication systems and apparatuses can be provided, which enables the communication suitably even when a difference arises between the remote control and the host apparatus in the effect suffered from the same source of disturbance, while avoiding the interference from sources of disturbance.

For example, in the remote control system based on RF4CE standards, the host apparatus determines the frequency channel on which the host apparatus itself is on receiving standby, and the remote control is configured simply to follow the frequency channel and does not avoid by changing to other channels even if only the side of the remote control is affected by disturbance waves. By contrast, according to the embodiments disclosed herein, in the case when a frequency channel exists on which the transmission is not feasible, and a response signal is not received even after transmitting a signal onto other frequency channels; the remote control is configured to be able to avoid the frequency channel in question by changing to other frequency channels by recognizing that a signal is not sent through on the frequency channel which the host apparatus is on receiving standby, and by transmitting a channel shift request to the host apparatus.

Further features and advantages of the present disclosure and the manner which it addresses the aforementioned problems, will become more apparent from the following detailed description when taken in conjunction with the accompanying drawings and detailed description.

### BRIEF DESCRIPTION OF THE DRAWINGS

FIG. 1 is a block diagram schematically illustrating the construction of a remote control system of RF type according to an embodiment of the present disclosure;

FIG. 2 illustrates the feature of the transmission of channel shift demand code from the remote control to the host apparatus;

FIG. 3 is a flow chart illustrating a processing procedure (initialization) performed by the remote control;

FIG. 4 is another flow chart illustrating the processing procedure (processing performed according to remote control operations by a user);

FIG. 5 is still another flow chart illustrating the processing procedure (processing for transmitting the remote control code and the channel shift demand code;

FIG. 6 is a drawing schematically illustrating the scheme for the host apparatus to avoid the interference from the disturbance waves;

FIG. 7 is a drawing schematically illustrating the scheme for the remote control to avoid disturbance waves based on CSMA;

FIG. 8 shows an example illustrating the difference in the distance from the source of disturbance to the host apparatus and the remote control;

FIG. 9 shows an example illustrating different installation environments for the host apparatus and the remote control;

FIG. 10 shows an example illustrating different mounting of antenna modules for the host apparatus and the remote control;

FIG. 11 illustrates the features of the difference in receiving level of disturbance waves between the remote control and the host apparatus; and

FIG. 12 illustrates the features of the frequency shift level on the side of the host apparatus set lower compared with the transmission shutoff level on the side of the remote control.

### DETAILED DESCRIPTION OF EMBODIMENTS

Referring now to the drawings, preferable embodiments for implementing the present disclosure are detailed hereinbelow.

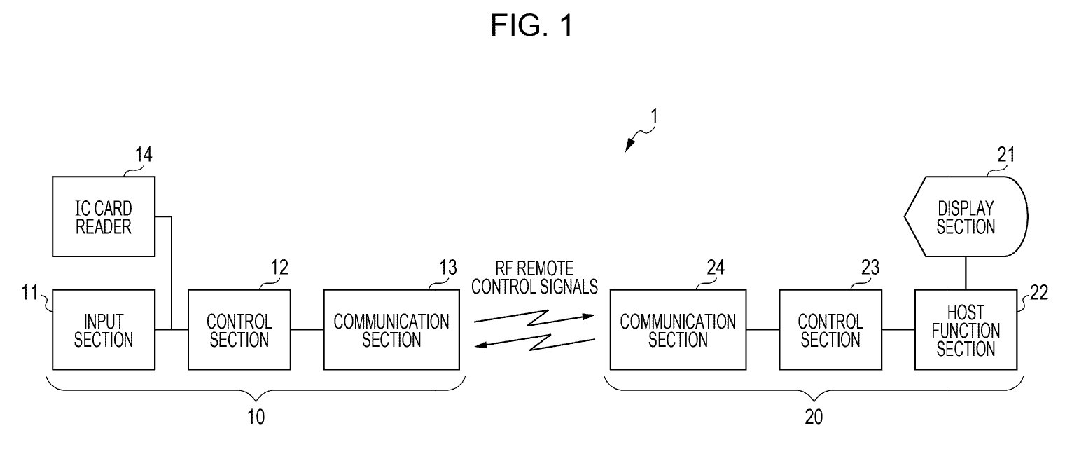

FIG. 1 is a block diagram schematically illustrating the construction of a remote control system 1 of RF type according to a first embodiment of the present disclosure. The remote control system 1 of illustration includes a remote control 10 for transmitting a remote control code with RF signals to implement an operation of the remote control, and a host apparatus 20 as subject of operation by the remote control code.

The remote control 10 is provided with an input section 11, a first control section 12, a first communication section 13, and an IC card reader 14.

The input section 11 is provided with a plurality of buttons, such as a cursor button, a numerical button, a select button, and other menu buttons. A user can perform remote control operations through the input section 11.

The first communication section 13 is configured to perform the processing primarily of PHY/MAC layers compliant with RF4CE, for example, and enter a wireless network as a terminal station. The remote control 10 performs bidirectional communications with the host apparatus 20 through the first communication section 13. After transmitting remote control codes with RF signals, if response signals are not received a predetermined number of times from the host apparatus 20, the frequency channel used in the first communication section 13 is switched and remote control codes are transmitted again. In addition, the first communication section 13 is configured to perform interference avoidance according to CSMA rules, so that no transmission is carried out on the frequency channel in which the energy level of received disturbance waves exceeds a transmission shutoff level (undermentioned).

The first control section 12 is configured to assume overall control over the operations of the remote control 10. For example, on pressing by a user any one of the buttons contained in the input section 11, the signal corresponding to the remote control code is sent out from the first communication section 13. Moreover, when an information transmission is performed on the side of the host apparatus 20, the first control section 12 instructs the first communications section 13 to receive the information as well process thus received information.

The IC card reader 14 is capable of performing a secure data transmission with IC cards over the transmission distance of zero to about several tens of centimeters through the communication system compliant with the international standards of ISO/IEC IS18092 (NFC IP-1) and so forth, for example. As primary uses, there mentioned are reading authentication information from IC cards, use of valuable information stored in the IC card, and so forth. For example, in the case of a television set as the host apparatus 20, it is feasible to pay the charge for using chargeable contents through the IC card reader 14 by holding an IC card (not shown) over to the remote control 10.

Meanwhile, the host apparatus 20 is provided with a display section 21, a host function section 22, a second control section 23, and a second communication section 24.

The second communication section 24 is configured to perform the processing primarily of PHY/MAC layers compliant with RF4CE, for example, manage the wireless network as an access point, and accommodate one or more terminal stations, such as the remote control 10. With RF4CE which is available on three frequency channels, the second communication section 24 is configured as the default to utilize the channel least interfering with the current system among the three channels. In addition, if the energy level of received disturbance wave exceeds a frequency shift level (undermentioned) during the mode of receiving standby on the frequency channel currently used, the second communication section 24 makes a shift to another frequency channel with reduced interference.

The display section 21 includes a liquid crystal display and so forth. The host function section 22 includes a television set, AV equipment, and other bodies of information appliances, to be operated by the remote control 10. The second control section 23 is configured to assume overall control over the operations of the host apparatus 20.

For example, on receiving a signal from the remote control 10 by the second communication section 24, the second control section 23 operates to carry out decode processing of the signal. If the received signal is one in remote control code, the second control section 23 instructs the host function section 22 to perform the processing shown in the remote control code. During operating the remote control, several menu items are displayed on the screen of the display section 11. Using the cursor button contained in the input section 11 of the remote control 10, the user can change the selection of menu items on the screen and confirm the selected menu item by further pressing the decision button. In addition, the host function section 22 may start applications according to the selected menu item, to generate the information to be transmitted to the remote control 10.

Three frequency channels are provided in RF4CE. Immediately after installing the host apparatus 20, the implementation of the scheme is specified, as the initial setting, to use the channel least interfering with the host apparatus 20 among the three frequency channels (mentioned earlier). In addition, since the optimal frequency channel changes with time, the reality is that each manufacturer mounts a scheme for appropriately implementing the transition to the optimal frequency channel in the portions which have not been specified by RF4CE.

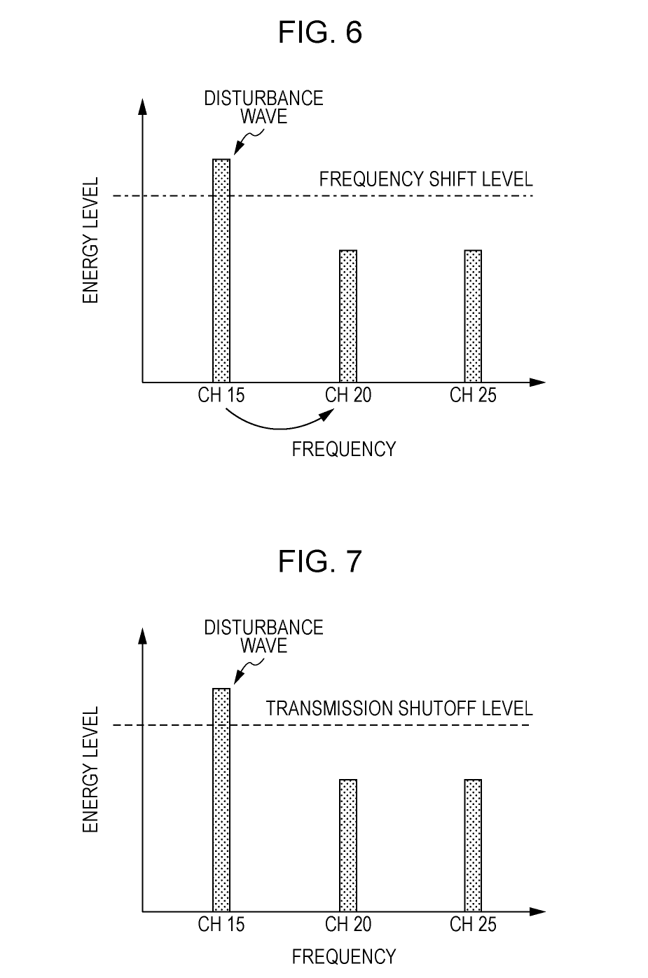

As an example of the method of the frequency channel shift, there mentioned is of shifting or changing the receiving frequency channel, if the energy level of the disturbance waves on the received frequency channel exceeds a certain predetermined level (hereafter referred to as “frequency shift level”) while the host apparatus 20 is in the mode of receiving standby of RF signal from the remote control 10. FIG. 6 is a drawing schematically illustrating the scheme for the host apparatus 20 to avoid the interference from the disturbance waves. In the example shown in the drawing, while the host apparatus 20 is in the mode of receiving standby on CH (frequency channel) 15, since the energy level of the disturbance wave on CH 15 exceeds the frequency shift level, the frequency channel for carrying out the receiving standby is now changed to either CH 20 or CH 25.

On the other hand, although the remote control 10 does not detect the current status itself that the host apparatus 20 has shifted the frequency channel, the remote control is configured to switch to other frequency channels, when RF signal was transmitted through the remote control operation by the user and its response signal ACK from the host apparatus 20 is not returned. That is, since the remote control 10 is configured to transmit onto all three frequency channels, it can correspond to the frequency channel change which the host apparatus 20 carried out.

When RF signal was transmitted through the remote control operation by the user, the remote control 10 carries out the transmission of RF signals one by one on three frequency channels until it receives ACK from the host apparatus 20. Since the host apparatus 10 is in receiving standby at least on one of the frequency channels, ACK will be returned on that frequency channel, as a result. The remote control then recognizes the frequency channel on which ACK was received, as the channel for use.

In addition, the remote control 10 performs interference avoidance according to the rules of CSMA. Namely, the remote control 10 checks the energy levels of disturbance waves before transmitting on each frequency channel. Subsequently, when a signal is found which exceeds a certain predetermined level (hereafter referred to as “transmission shutoff level”) on a frequency channel, the transmission is carried out, not on that frequency channel but only on other frequency channels with low signal levels, in order not to reach the partner even being transmitted and not to disturb the abovementioned signal.

FIG. 7 is a drawing schematically illustrating the scheme for the remote control 10 to avoid disturbance waves based on CSMA. For example, it is assumed that the remote control 10 has been able to receive ACK on CH 15 until now. Before carrying out any transmission on CH 15 in response to a user's remote control operation, the energy level of disturbance waves on the relevant frequency channel is measured. When it is confirmed that the measured level exceeds the transmission shutoff level, the remote control 10 does not transmit on CH 15, but can transmit one by one only on other frequency channels such as CH 20 and CH 25, on which the energy levels of disturbance waves do not exceed the transmission shutoff level.

As for the general wireless network, a communication over a wall is also expected. By contrast, in the RF type remote control system, remote control operations are performed normally in the same room. Namely, the remote control 10 and the host apparatus 20 are located relatively close to each other, and even if a source of the disturbance exists, it is assumed that the energy level of the disturbance wave, which is received respectively by the remote control 10 and host apparatus 20, is in the same order of magnitude. In such a case, on the frequency channel which the remote control 10 does not transmit at all according to CSMA, since the interference affects similarly onto the side of the host apparatus 20 to thereby change automatically to other frequency channels, it is possible to constantly communicate while avoiding the interference with each other.

However, for some reason, if a difference arises between the remote control 10 and the host apparatus 20 in the influence from the same source of disturbance, particularly, as in the case where the remote control 10 suffers from the interference at a strong level while the level of the interference suffered by the host apparatus 20 is weaker, there is a possibility of getting into a situation where the transmission from the remote control 10 is not feasible (remote control operation being ineffective). This is caused by the fact that the host apparatus 20 does not shift the frequency channel, while the remote control 10 does not change to the frequency channel which the host apparatus 20 utilizes according to CSMA.

The following may be mentioned as the causes for the difference arising between the remote control 10 and the host apparatus 20 in the interference from the same source of disturbance.

(1) Due to the distance from the source of disturbance.

(2) Due to the installation environment of the host apparatus 20 and the remote control 10.

(3) Due to the mounting of antenna module.

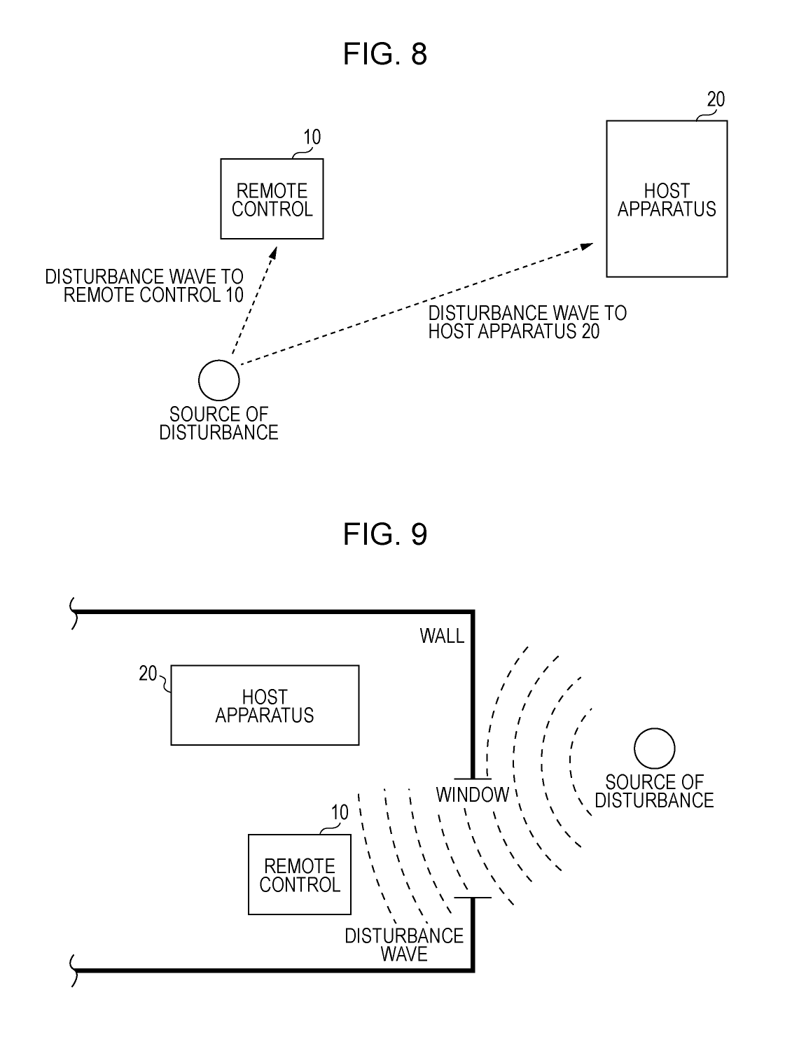

FIG. 8 shows an example of the difference in the distance from the source of disturbance to the host apparatus and the remote control 10. Since the distance to the remote control 10 is closer, the energy level of disturbance waves exceeds the transmission shutoff level. On the other hand, since the host apparatus 20 is farther in the distance from the source of disturbance, disturbance waves are attenuated and the received energy level comes to be below the frequency shift level.

FIG. 9 shows an example of different installation environments for the host apparatus 20 and the remote control 10. In the exemplary illustration, the source of disturbance is located outside the room, and disturbance waves do not pass a wall but enter from a window. The remote control 10 is at the location capable of receiving the disturbances entering from the window, and the energy level of disturbance waves to be received exceeds the transmission shutoff level. By contrast, the host apparatus 20 is hidden behind the wall, the energy level of the disturbance waves comes to be below the frequency shift level.

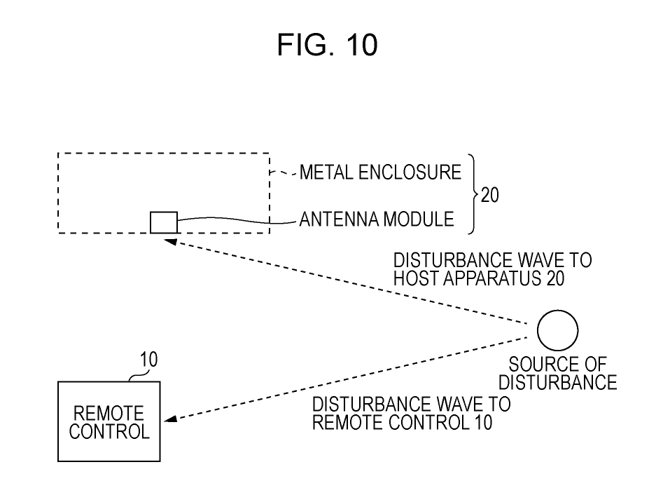

In addition, FIG. 10 shows an example of different mounting of antenna modules the host apparatus 20 and the remote control 10. Because of its antenna module being built-in in metal enclosure, the host apparatus 20 has low receiver sensitivity to begin with. As a result, even if the distance from the disturbance source is almost the same to the host apparatus 20 and the remote control 10, as illustrated in the drawing, while the energy level of disturbance waves exceeds the transmission shutoff level on the side of the remote control 10, the energy level of disturbance waves is less than the frequency shift level on the side of the host apparatus 20.

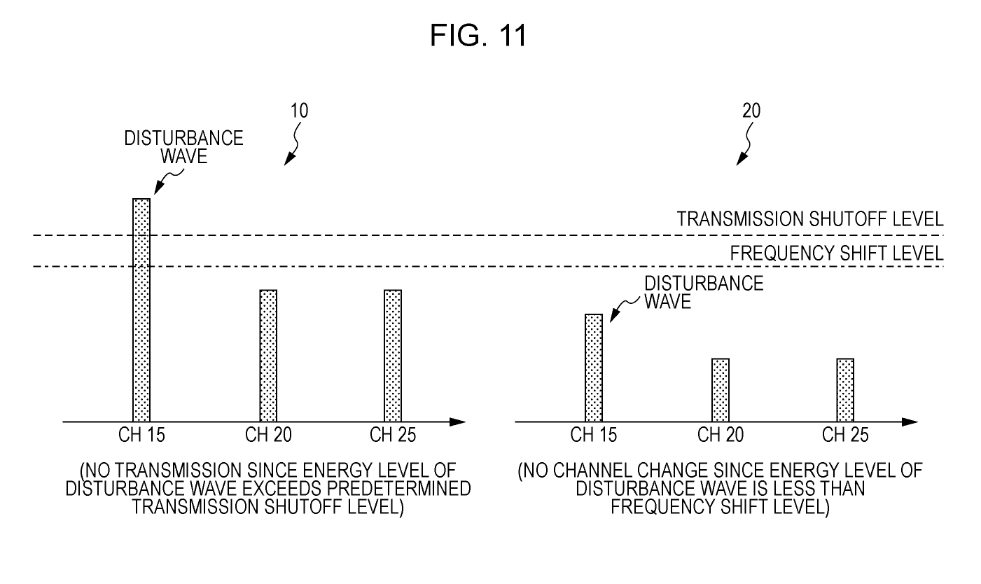

FIG. 11 illustrates the features of the difference in receiving level of disturbance waves between the remote control 10 and the host apparatus 20. In the present drawing, it is assumed that the frequency channel to be used is set to CH 15 by the host apparatus 20.

The remote control 10 has received so far the response signal ACK on the frequency channel CH 15 from the host apparatus 20, thereby recognizing the frequency channel to be used being CH 15.

Subsequently, before carrying out any transmission on CH 15 in response to user's remote control operation, the remote control 10 measures the energy level of disturbance waves on the relevant frequency channel. In the example illustrated in FIG. 11, since the energy level of disturbance waves on CH 15 has been found in excess of the transmission shutoff level, which is caused by subsequent changes in the communication environments and so forth, the transmission is not carried out onto CH 15. Instead, the remote control 10 performs the transmission one by one only on other frequency channels such as CH 20 and CH 25, on which the energy level of disturbance waves does not exceed the transmission shutoff level.

On the other hand, while in the mode of receiving standby of RF signal from the remote control 10, the host apparatus 20 monitors the energy level of disturbance waves on the received frequency channel CH 15. In the example illustrated in FIG. 11, since the energy level of disturbance waves is less than the frequency shift level on any of the frequency channels, the change of frequency is not carried out.

As a result, while the host apparatus 20 is continuously in the mode of receiving standby on the frequency channel CH 15, the remote control 10 does not transmit on CH 15 according to CSMA, but comes to operate the transmission by switching one by one to other frequency channels such as CH 20 and CH 25. While the host apparatus 20 does not make the frequency channel change, the remote control 10 does not access to the frequency channel which the host apparatus 20 utilizes according to CSMA, the remote control operation thus becomes ineffective.

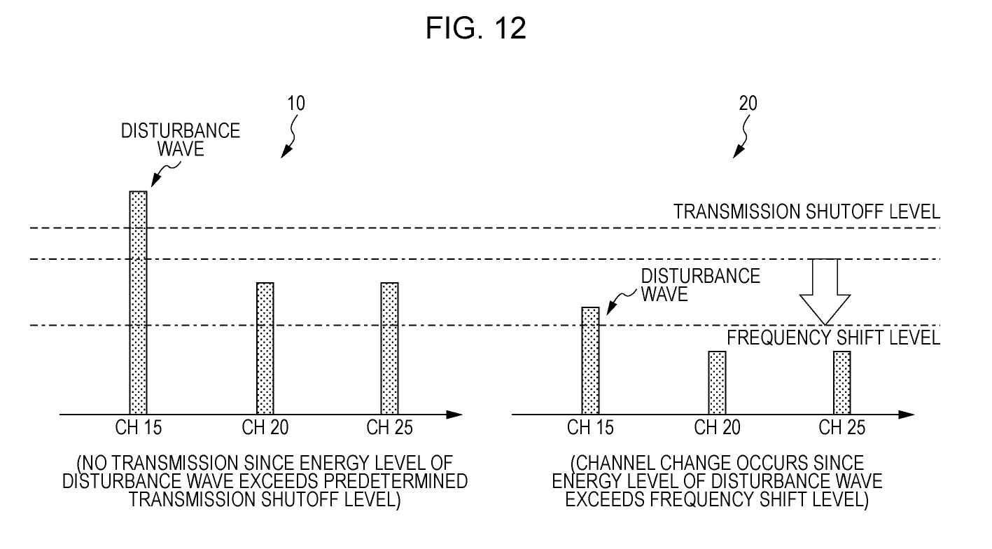

As shown in FIG. 10, in the case where the mounting of antenna module is considered as the cause for resulting the difference in the influence received from the same source of disturbance by the remote control 10 and the host apparatus 20, the abovementioned difficulty can be resolved by decreasing the frequency shift level. Namely, the difference in the influence received from the same source of disturbance between the remote control and the host apparatus can be compensated by differentiating the transmission shutoff level and the frequency shift level. As shown in FIG. 12, by setting the frequency shift level on the side of the host apparatus 20 to be lower compared with the transmission shutoff level on the side of the remote control 10, since the host apparatus 20 makes a change to other frequency channels such as CH 20 and CH 25, it becomes feasible for the remote control 10 to transmit remote control codes to the host apparatus 20 on CH 20 and CH 25.

However, when the frequency shift level is set too low, since the change of frequency channel takes place more frequently on the side of the host apparatus 20, the response to remote control operation may become slow, or the operation becomes unstable. In addition, this method of lowering the frequency shift level does not furnish a satisfactory solution to the problems due to the difference in the distance from the source of disturbance (see FIG. 9) and in the installation environment (see FIG. 10).

With the method of measuring the energy level of disturbance waves on each available frequency channel when the host apparatus is installed, and then changing to the least interfering channel, a proper corresponding measure is not maintained when subsequent changes take place in the optimal channel.

In addition, a method is disclosed in Japanese Unexamined Patent Application Publication No. 2009-267560, in which a host apparatus periodically measures the received field intensity on each available frequency channel and then makes a shift to the least interfering channel (mentioned previously). However, according to this method as illustrated in FIGS. 8 through 10, the disturbance waves received only on the side of remote control are not avoided. Moreover, in order to select the optimal channel, it is necessary to measure the received field intensity every several seconds and on every available channel, this renders the remote control ineffective during the measurements. If such operation is carried out regularly, the time period of the remote control not effective will take place regularly.

When the remote control 10 transmitted RF signal on one of the frequency channels, the remote control can recognize that the remote control code reached the host apparatus 20 by properly receiving the response signal ACK from the host apparatus 20 on that frequency channel.

On the other hand, the situation, where remote control codes do not reach the host apparatus 20, primarily arises in the installation environment where the remote control 10 is located closer in the distance from the source of disturbance while the host apparatus 20 is further from the source. Referring again to FIG. 11, the remote control 10 does not transmit on CH 15 according to CSMA, and even after transmitting on other frequency channels such as CH 20 and CH 25, a response signal ACK from host apparatus 20 is not returned either. On the side of the host apparatus 20, by contrast, since there is less influence of disturbance waves, the mode of receiving standby is continued on the frequency channel CH 15, it does not take place to receive signals transmitted from the remote control 10 onto other frequency channels such as CH 20 and CH 25, and to subsequently return ACK signal.

The present inventor focuses attention on the point, in that the remote control 10 can make an assumption that the frequency channel exists, on which the transmission is not feasible according to CSMA; and subsequently make another assumption, when response signals ACK could not be received even after performing the transmission sequentially a predetermined times onto the frequency channels other than the abovementioned frequency channel, that only the remote control 10 suffers from the influence of disturbance waves, and remote control codes have not reached the host apparatus 20. Accordingly, an interference avoidance method is herewith proposed, in that the remote control 10 is configured to transmit a channel shift demand code to the host apparatus 20, in the case where a frequency channel is found to exist, on which the transmission is not feasible according to CSMA, and where the state persists so as for response signals ACK not to be received even after transmitting consecutively a predetermined times onto the other frequency channels than the abovementioned channel.

The remote control 10 transmits a channel shift demand code sequentially onto each frequency channel. If the remote control operation is not effective, since a user often has the habit of repeating control operations while changing the way of holding the remote control 10, it can be expected that the RF signal corresponding to one of such remote control operations as above will reach the host apparatus 20. On receiving the channel shift demand code, the host apparatus 20 can recognize that the side of the remote control 10 is suffering from the influence of disturbance waves, and makes several changes sequentially to other frequency channels in order to avoid the influence. The channel shift demand code transmitted by the remote control 10 may include the information of the frequency channel to be changed. In this case, the host apparatus 20 can change to the frequency channel directed by the channel shift demand code, and just remain in the receiving standby mode. Subsequently, when the remote control 10 made a change to the frequency channel on which the transmission can be performed according to CSMA, the host apparatus 20 comes to be able to receive the RF signal from the remote control 10, and remote control operations comes to be effective from this time on.

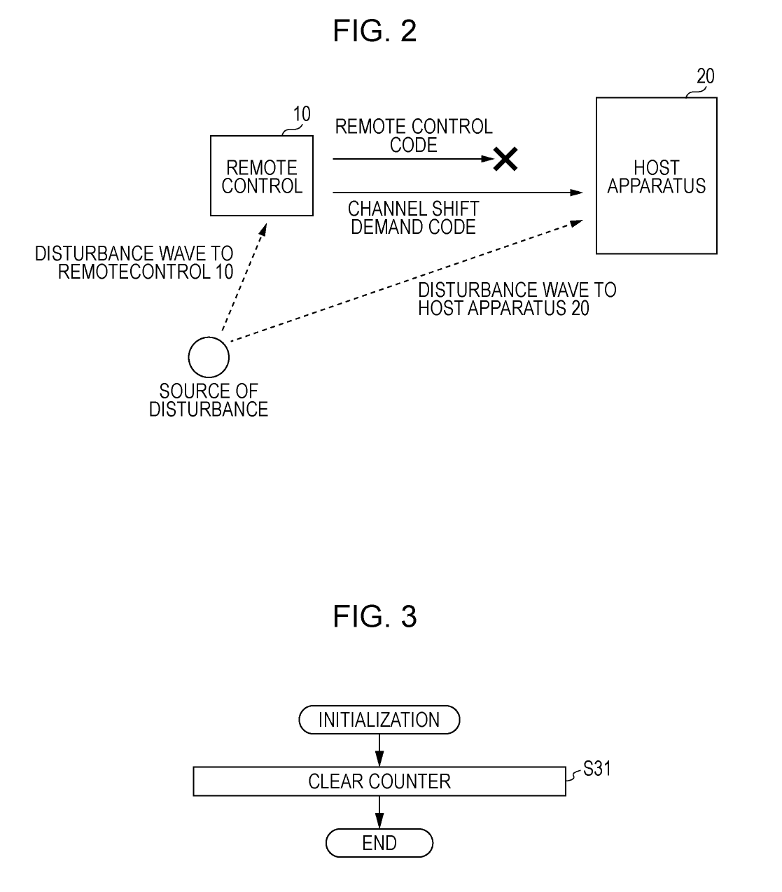

FIG. 2 illustrates the features of the transmission of channel shift demand code from the remote control 10 to the host apparatus 20.

The remote control 10 sends a remote control code when a remote control operation is performed by a user, and whether this code reached the host apparatus 20 is verified by two conditions; the transmission was able to be carried out according to CSMA, and the ACK signal has received from the host apparatus 20. In the example shown in FIG. 2, since the remote control 10 is located close to the source of disturbance, the energy level of disturbance waves is strong and the communication is not stable, as a result. On the other hand, the host apparatus is located further from the source of disturbance, and the energy level of disturbance waves is weak. Namely, since the source of disturbance is close to the remote control 10 while far from the host apparatus 20, the situation arises where remote control codes do not reach the host apparatus 20.

If the occurrence, that the remote control code does not reach the host apparatus 20, takes place frequently, the remote control 10 sends a channel shift demand code to the host apparatus 20. On receiving the channel shift demand code, the host apparatus 20 changes the frequency channel on which the receiving standby is carried out. The channel shift demand code transmitted by the remote control 10 may include the frequency channel to be shifted. In this case, the host apparatus 20 makes a change to the frequency channel directed by the channel shift demand code, and may remain in the receiving standby mode. If the remote control 10 comes not to be suffered from disturbance on thus changed frequency channel, stable transmissions of the remote control code become feasible.

Although there may be considered, of course, the situation that the channel shift demand code also does not reach the host apparatus 20 interfered by the source of disturbance, but that is not entirely so. If the remote control operation is not effective, a user has the habit of repeating control operations many times while changing the way of holding the remote control 10. If a channel shift demand code could reach the host apparatus 20 by any one of such remote control operations, the frequency channel can be changed. In addition, when a remote control does not communicate at all even after the user repeated remote control operations at the same location, since the user brings remote control 10 closer to the host apparatus 20, the communication may become feasible. If a channel shift demand code then reaches the host apparatus 20, the frequency channel is changed.

FIGS. 3 through 5 are flow charts illustrating processing procedures performed by the remote control 10.

As mentioned above, when a frequency channel is found to exist, on which the transmission is not feasible according to CSMA, and when the state persists so as for response signals ACK not to be received even after sending consecutively a predetermined times onto the other frequency channels than the abovementioned channel, the remote control 10 sends a channel shift demand code to the host apparatus 20. In the processing procedure shown in FIG. 3, the processing is performed for initializing (clearing) the counter which is configured to count the state where a reply signal ACK is not received (step S31).

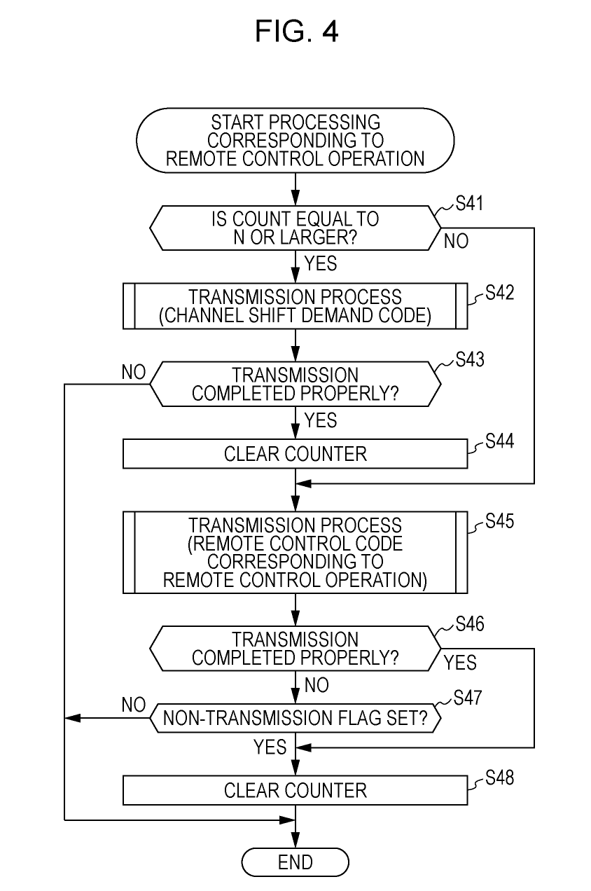

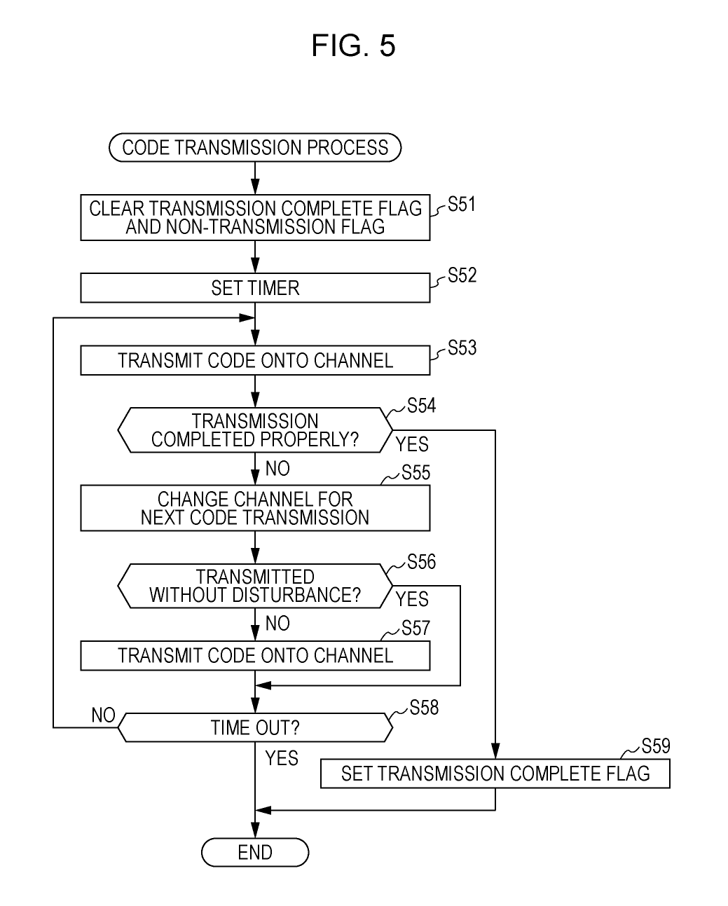

FIG. 4 illustrates the processing procedure which the remote control 10 performs according to remote control operations by a user. It is noted that the term “transmission complete flag” included in the drawing indicates that the transmission processing is completed, while “non-transmission flag” indicates that the transmission is not feasible according to CSMA (due to disturbance waves), and each of the flags is managed in the transmission processing shown in FIG. 5 (undermentioned).

On receiving a remote control code and a channel shift demand code, the host apparatus 20 returns response signals ACK to each of the abovementioned codes. In addition, the remote control 10 instructs a counter to count the number of times that a response signal ACK is not received after sending out either the remote control code or channel shift demand code.

If a user performed a remote control operation, the counter checks at first regarding whether its count is more than the predetermined number of times N (step S41). If the count is less than N, namely, until the number of times reach the number N, in which the reply signal ACK was not able to receive continuously (NO at step S41), the process proceeds to step S45 and the transmission processing of a remote control code to the host apparatus 20 is carried out. The processing procedure for performing the transmission processing of the remote control code is illustrated in FIG. 5, and will be detailed later on.

By contrast, if the count exceeds the predetermined number of times N, namely, a frequency channel is found to exist on which the transmission was not feasible, and the response signals ACK could not be received continuously over the predetermined number of times (YES at step S41), the transmission processing of a channel shift demand code to the host apparatus 20 is carried out (step S42). The channel shift demand code may include the frequency channel to be shifted. The processing procedure for performing the transmission processing of the channel shift demand code is illustrated in FIG. 5, and will be detailed later on.

Subsequently, with reference to the transmission complete flag, it is checked as to whether the transmission of the channel shift demand code was properly completed (step S43).

If the transmission of the channel shift demand code was properly completed (YES at step S43), the counter is cleared (step S44), but if the transmission of the channel shift demand code has not been completed (NO at step S43), the value of the counter is left as it is and the entire process flow ends.

In addition, with reference to the transmission complete flag, it is checked as to whether the transmission of the remote control code was properly completed (step S46).

If the transmission of the remote control code was completed properly (YES at step S46), the counter is cleared (step S48) and the entire process flow ends.

On the other hand, if the transmission of the remote control code has not been completed (NO at step S46), it is subsequently checked with reference to the non-transmission flag as to whether there was any case where the remote control code was unable to be transmitted according to CSMA (due to disturbance waves) (step S47). At this point, if the non-transmission flag was set (YES at step S47), the counter is incremented (step S48), and then the entire process flow ends. By contrast, if the non-transmission flag is not set (NO at step S47), and the entire process flow ends as it is.

FIG. 5 illustrates the processing procedure for the remote control 10 to transmit the remote control code and the channel shift demand code. The relevant processing procedure is invoked at steps S42 and S45 in the flow chart shown in FIG. 4.

When such processing procedure is invoked, firstly cleared are both the “transmission complete flag” indicating that the transmission processing is completed, and the “non-transmission flag” indicating that the transmission is not feasible according to CSMA (due to disturbance waves) (step S51). Subsequently, a timer is set to time out the relevant processing procedure (step S52).

Thereafter, the transmission of RF signal (remote control code or channel shift demand code) is attempted onto the frequency channel currently set (step S53).

Subsequently, when a response signal ACK was able to be received from the host apparatus 20 as communication partner and the code transmission was properly completed (YES at step S54), the transmission complete flag is set (step S59) and the entire process flow ends.

On the other hand, when the response signal ACK from host apparatus 20 was not received (in inclusive of the case where the response signal ACK could not be sent from the side of the host apparatus 20 due to disturbance waves), and when the code transmission was not completed properly (NO at step S54), the frequency channel to be transmitted next is changed (step S55).

Thereafter, it is checked as to whether the transmission at step S43 according to CSMA was completed without disturbance (step S56). At this point, when the transmission was not feasible according to CSMA (due to disturbance waves) (NO at step S56), a non-transmission flag is set (step S57).

Subsequently, the processing of the abovementioned steps S53 through S57 are carried out repeatedly until time-out (NO at step S58).

Incidentally, the time-out period of about one second is suitable, for example, and not particularly limited thereto. In RF4CE, retransmissions of about 150 to 180 times are possible in 1 second.

At the end of the process flow shown in FIG. 5, when the transmission was completed properly, the transmission complete flag is set. By contrast, when there is found the case where the transmission was not feasible according to CSMA even once during repeating the retransmission, the non-transmission flag is set.

Although the foregoing explanation is made primarily regarding to several embodiments applied to remote control system which includes the remote control and the host apparatus as subject of operation by the remote control, the gist of the disclosure is not limited thereto. For example, the disclosure is also applicable to various wireless communication systems which perform the bidirectional communication. In addition, although the embodiments have been described mostly about the remote control system in accordance with RF4CE, the present disclosure is not limited to any particular standard.

While the present disclosure has been detailed hereinabove with reference to preferred embodiments, the foregoing description is intended to be illustrative, but not limiting.

What is claimed is:

1. A communication system, comprising:
a remote control including
an input section for inputting a user operation and a first communication section for performing a bidirectional communication on any one of at least two frequency channels, so as to transmit a remote control code corresponding to the user operation of the input section; and
a host apparatus including a second communication section for performing a bidirectional communication on any one of the at least two frequency channels and a host function section for performing processing according to the remote control code received by the second communication section;
wherein
the host apparatus is configured to determine a frequency channel for the second communication section to be on receiving standby, the remote control is configured to transmit a channel shift request to the host apparatus when a signal is not sent through on the frequency channel which the host apparatus is on receiving standby, and the host apparatus is also configured to change the frequency channel on which the second communication section is on receiving standby after receiving the channel shift request.

2. The communication system according to claim 1, wherein
the remote control directs the frequency channel to be changed through the channel shift request, and
the host apparatus changes the frequency channel on which the second communication section is on receiving standby to the frequency channel directed through the channel shift request received.

3. The communication system according to claim 1, wherein
the host apparatus returns a response signal on receiving a signal from the remote control; and wherein,
in a case when a transmission is not carried out on the frequency channel in which an energy level of disturbance waves exceeds a predetermined transmission shutoff level, another signal is transmitted after changing the frequency channel when a response signal is not received, and a response signal can be received from the host apparatus on the frequency channel onto which the another signal was transmitted; the remote control recognizes that the host apparatus is on receiving standby on the frequency channel.

4. The communication system according to claim 3, wherein,
in a case where a frequency channel exists on which the transmission is not feasible, and a response signal is not received even after performing the transmission sequentially more than a predetermined times onto the frequency channels other than the abovementioned frequency channel; the remote control transmits a channel shift request to the host apparatus.

5. A communication device functioning as a remote control, the communication device comprising:
an input section for inputting a user operation; and
a communication section for performing a bidirectional communication on any one of at least two frequency channels;
wherein
the communication device is configured to transmit a remote control code corresponding to a user operation of the input section from the communication section to a host apparatus to be a subject of operation, and transmit a channel shift request to the host apparatus when a signal is not sent through on the frequency channel which the host apparatus is on receiving standby.

6. The communication device according to claim 5, wherein
the communication device directs the frequency channel to be changed through the channel shift request.

7. The communication device according to claim 5, wherein
the host apparatus is configured to return a response signal on receiving a signal from the remote control, and wherein,
in a case when a transmission is not carried out on the frequency channel in which an energy level of disturbance waves exceeds a predetermined transmission shutoff level, another signal is transmitted after changing the frequency channel when a response signal is not received, and a response signal can be received from the host apparatus on the frequency channel onto which the another signal was transmitted; the communication section recognizes that the host apparatus is on receiving standby on the frequency channel.

8. The communication device according to claim 7, wherein,
in a case where a frequency channel exists on which the transmission is not feasible, and a response signal is not received even after performing the transmission sequentially more than a predetermined times onto the frequency channels other than the abovementioned frequency channel; the communication section transmits a channel shift request to the host apparatus.

9. A communication device as a subject of operation by a remote control, the communication device comprising:
a communication section for performing a bidirectional communication with a remote control on any one of at least two frequency channels; and a host function section for performing processing according to a remote control code received by the communication section, wherein
the communication section determines a frequency channel to be on receiving standby, and changes the frequency channel on receiving standby in response to a reception of the channel shift request from the remote control.

10. The communication device according to claim 9, wherein
the frequency channel to be changed is directed by the channel shift request received, and the communication section changes the frequency channel on receiving standby to the frequency channel directed by the channel shift request received.
